(19) United States
(12) Patent Application Publication
(10) Pub. No.: US 2012/0267958 A1
(43) Pub. Date: Oct. 25, 2012

(54) CURRENT SUPPRESSION CIRCUIT AND ELECTRONIC DEVICE EMPLOYING THE SAME

(75) Inventor: CHUAN-TSAI HOU, Tu-Cheng (TW)

(73) Assignee: HON HAI PRECISION INDUSTRY CO., LTD., Tu-Cheng (TW)

(21) Appl. No.: 13/177,985

(22) Filed: Jul. 7, 2011

(30) Foreign Application Priority Data
Apr. 25, 2011 (TW) 100114342

(51) Int. Cl. H02J 1/00

(52) U.S. Cl. 307/80

(57) ABSTRACT

A current suppression circuit for an electronic device and includes a main power supply and a standby power supply. The current suppression circuit includes a voltage comparator and an electronic switch. The voltage comparator includes a non-inverting input, an inverting input, and an output. The non-inverting input and the inverting input are respectively connected to the main power supply and the standby power supply, and the output is connected to the electronic switch. Whether the electronic switch is turned on or off by virtue of by the voltage comparator, such that when the electronic device itself is powered off, the comparator outputs a voltage signal to the electronic switch to turn it off, and the standby power supply is disconnected from the components.

### BACKGROUND

1. Technical field

The disclosure generally relates to suppression circuits, and more particularly to a current suppression circuit and an electronic device employing the same.

2. Description of the Related Art

Different electronic components in mobile phone, computer or other electronic devices usually work at different rated voltages. For instance, the rated voltage of a microprocessor is 3.3V, the rated voltage of an input/output (I/O) microchip is 5V, thereby, a potential difference exists between the microprocessor and the I/O microchip. Hence, a voltage isolating circuit is generally used to protect the microprocessor from overvoltage.

However, often, even when the device is powered off, a standby power supply is still available to power the electronic component, resulting in waste of power.

Therefore, there is room for improvement within the art.

### BRIEF DESCRIPTION OF THE DRAWINGS

Many aspects of a current suppression circuit and an electronic device employing the same can be better understood with reference to the following drawings. The components in the drawings are not necessarily drawn to scale, the emphasis instead being placed upon clearly illustrating the principles of the current suppression circuit and an electronic device employing the same. Moreover, in the drawings, like reference numerals designate corresponding parts throughout the several views. Wherever possible, the same reference numbers are used throughout the drawings to refer to the same or like elements of an embodiment.

FIG. 1 is a block view of one embodiment of an electronic device.

FIG. 2 is a circuit view of the electronic device shown in FIG. 1.

### DETAILED DESCRIPTION

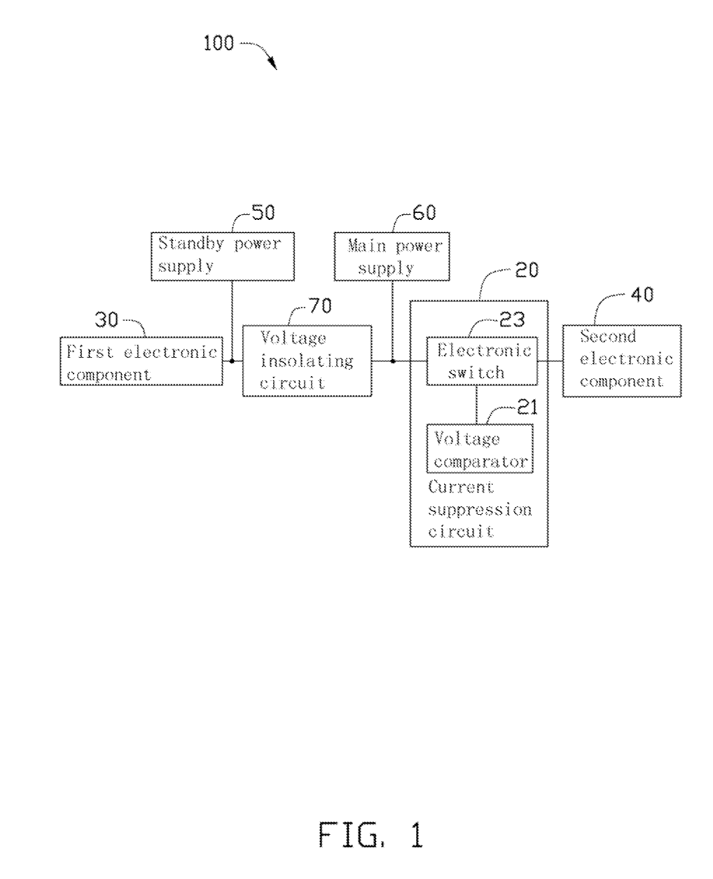

FIG. 1 shows a block view of one embodiment of an electronic device 100. The electronic device 100 can be a mobile phone, a personal digital assistant, or a computer. The electronic device 100 includes a current suppression circuit 20, a first electronic component 30, a second electronic component 40, a standby power supply 50, a main power supply 60, and a voltage insolating circuit 70. The first electronic component 30, the voltage insolating circuit 70, the current suppression circuit 20 and the second electronic component 40 are electrically connected in series.

In this embodiment, the first electronic component 30 can be a microprocessor, and the second electronic component 40 can be a network interface card or an input/output microchip. The standby power supply 50 is electrically connected between the first electronic component 30 and the voltage insolating circuit 70 to power the first electronic component 30. The main power supply 60 is electrically connected between the voltage insolating circuit 70 and the current suppression circuit 20 so the voltage insolating circuit 70 electrically stands between the standby power supply 50 and the main power supply 60. Thus, the first electronic component 30 and the second electronic component 40 obtain rated operating voltages from the standby power supply 50 and the main power supply 60 respectively.

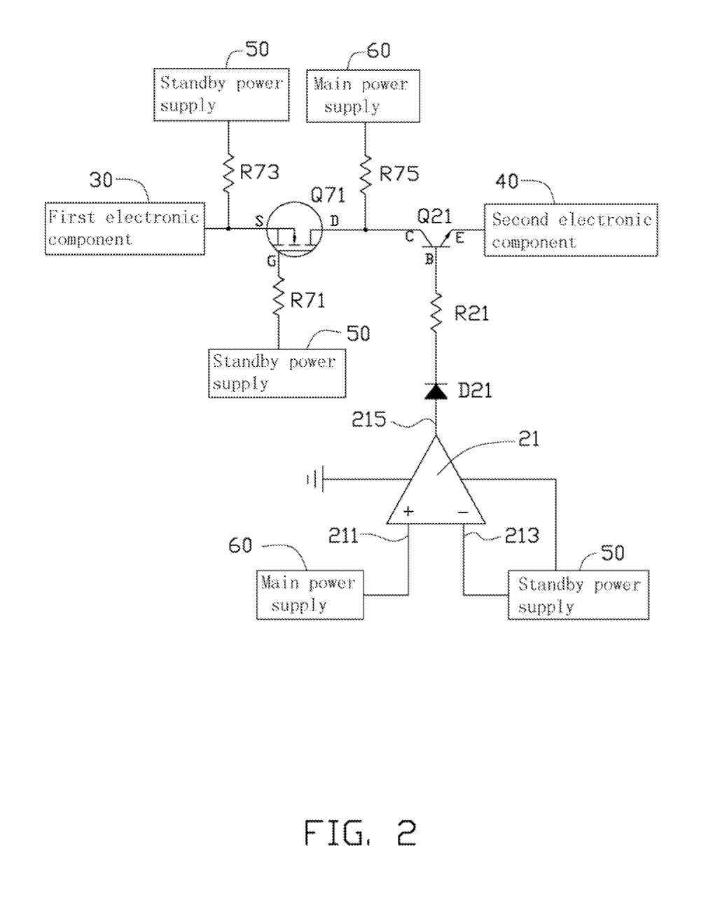

Referring to FIG. 2, in this embodiment, the voltage insolating circuit 70 includes a metal-oxide-semiconductor field-effect transistor (MOSFET) Q71, a first resistor R71, a second resistor R73, and a third resistor R75. The MOSFET Q71 includes a source S, a gate G, and a drain D. The resistors R71, R73 and R75 are pull-up resistors.

The source S of the MOSFET Q71 is electrically connected to the first electronic component 30, the gate G of the MOSFET Q71 is electrically connected to the standby power source 50 through the first resistor R71. The source S of the MOSFET Q71 is further electrically connected to the standby power supply 50 through the second resistor R73, and the drain D of the MOSFET Q71 is electrically connected to the main power supply 60 through the third resistor R75.

The voltage of the main power supply 60 is greater than the voltage of the standby power supply 50. In this embodiment, the voltage of the main power supply 60 is 5V, and the voltage of the standby power supply is 3.3V. In another embodiment, the voltage of the main power supply 60 can be 12V, and the voltage of the standby power supply can be 3.3V or 5V accordingly.

The current suppression circuit 20 is electrically connected between the voltage insolating circuit 70 and the second electronic component 40. The current suppression circuit 20 includes a voltage comparator 21, an electronic switch 23, a diode D21, and a current limiting resistor R21. The voltage comparator 21 is capable of switching the electronic switch 23 on or off. In this embodiment, the electronic switch 23 is an npn transistor Q21, the npn transistor Q21 includes a base B, an emitter E, and a collector C. The electronic switch 23 also can be an N-channel MOSFET including a gate, a source, and a drain, which respectively corresponds to the base B, the emitter E, and the collector C of the npn transistor Q21.

The voltage comparator 21 includes a non-inverting input 211, an inverting input 213, and an output 215. In this embodiment, the non-inverting input 211 and the inverting input 213 are respectively and electrically connected to the main power supply 60 and the standby power supply 50, and the output 215 of the voltage comparator 21 connects to the anode of the diode D21. The cathode of the diode D21 is electrically connected to the base B of the transistor Q21 through the current limiting resistor R21. The collector C of the transistor Q21 is electrically connected to the drain D of the MOSFET Q71, and the emitter E of the transistor Q21 is electrically connected to the second electronic component 40.

In this embodiment, the threshold voltage of the npn transistor Q21 is substantially 0.7V. The diode D21 allows an electric current to pass in one direction, while blocking current in the opposite direction. The voltage drop of the diode D21 is substantially 0.7V, and the diode D21 is capable of filtering out noise which might possibly interfere with the operation of the npn transistor Q21.

Further referring to FIGS. 1 and 2, in use, when the electronic device 100 is powered on and is activated, the standby power supply 50 and the main power supply 60 provide electricity to the inverting input 213 and the non-inverting input 211 of the voltage comparator 21. The voltage (e.g., 5V) of the non-inverting input 211 is greater than that of the inverting input 213, therefore, the output 215 of the voltage comparator 21 outputs a high voltage signal (e.g., logical 1) to the anode of the diode D21, enabling the diode D21 to conduct. Since the transistor Q21 is switched on, and the MOSFET Q71 is switched on, thereby, the first electronic device 30 communicates with the second electronic device 40 through the voltage insolating circuit 70 and the transistor Q21 to allow the carriage of data.

When the electronic device 100 is powered off, the standby power supply 50 still provides electricity for the inverting input 213, but the main power supply 60 is cut off and provides no power to the non-inverting input 211. Since the voltage (e.g., 3.3V) of the inverting input 213 is now greater than that of the non-inverting input 211, the output 215 outputs a low voltage signal (e.g., logical 0) to the anode of the diode D21. Thus, the diode D21 and the transistor Q21 are switched off and cease operating, so the standby power supply 50 is unavailable for the second electronic device 40.

In the electronic device 100 of the embodiment of this disclosure, the voltage comparator 21 outputs corresponding voltage signals, so that when the electronic device 100 is powered off, the electronic switch 23 is turned off by virtue of the corresponding voltage signal. Thus, the standby power supply 50 is disconnected from the second electronic component 40, which can save electricity and maintain the stability of an operating system.

In the present specification and claims the word “a” or “an” preceding an element does not exclude the presence of a plurality of such elements. Further, the word “comprising” does not exclude the presence of other elements or steps than those listed.

It is to be understood, however, that even though numerous characteristics and advantages of the disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A current suppression circuit used in an electronic device including a main power supply and a standby power supply, the current suppression circuit comprising:
a voltage comparator comprising:
a non-inverting input electrically connected to the main power supply;
an inverting input electrically connected to the standby power supply; and
an output; and
an electronic switch electrically connected to the output of the voltage comparator, wherein whether the electronic switch is turned on or off is controlled by the voltage comparator, such that when the electronic device is powered off, the output of the voltage comparator outputs a voltage signal to the electronic switch, and the electronic switch is switched off, and the standby power supply is disconnected from an electronic component.

2. The current suppression circuit as claimed in claim 1, wherein the electronic switch is an N-channel metallic-oxide semiconductor field-effect transistor.

3. The current suppression circuit as claimed in claim 1, wherein the electronic switch is an npn transistor.

4. The current suppression circuit as claimed in claim 1, further comprising a diode and a current limiting resistor, wherein the diode comprises an anode and cathode, the output of the voltage comparator is electrically connected to the anode of the diode, and the cathode of the diode is electrically connected to the electronic switch through the current limiting resistor.

5. The current suppression circuit as claimed in claim 4, wherein the potential difference of the diode is substantial 0.7V, and the diode filters out noise to avoid interfering with the electronic switch.

6. The current suppression circuit as claimed in claim 4, wherein when the electronic device is activated, the standby power supply and the main power supply provide electricity to the inverting input and the non-inverting input of the voltage comparator, and the voltage of the non-inverting input is greater than the voltage of the inverting input, the output of the voltage comparator outputs a high voltage signal to the diode, the electronic switch is switched on.

7. The current suppression circuit as claimed in claim 6, wherein when the electronic device is powered off, the standby power supply provides electricity for the inverting input, and the main power supply is cut off and provides no power to the non-inverting input, the voltage of the inverting input is greater than that of the non-inverting input, the output outputs a low voltage signal to the diode, the diode and the electronic switch are switched off and cease operating, and the standby power supply is made unavailable for the electronic device.

8. An electronic device comprising:
a first electronic component;
a voltage insolating circuit electrically connected to the first electronic component;
a standby power supply electrically connected between the voltage insolating circuit and the first electronic component;
a second electronic component;
a main power supply electrically connected to the voltage insolating circuit; and
a current suppression circuit electrically connected between the voltage insolating circuit and the second electronic component, the current suppression circuit comprising:
a voltage comparator comprising a non-inverting input, an inverting input, and an output, the non-inverting input and the inverting input electrically connected to the main power supply and the standby power supply respectively; and
an electronic switch electrically connected to the output of the voltage comparator, wherein whether the electronic switch is switched on or off is under the control of the voltage comparator, such that when the electronic device is activated, the electronic switch is turned on, the first electronic component communicates with second electronic component, when the electronic device is powered off, the output of the comparator outputs a voltage signal to the electronic switch, and the electronic switch is switched off, and the standby power supply is disconnected from an electronic component.

9. The electronic device as claimed in claim 8, wherein the electronic switch is an npn transistor comprising base, an emitter, and a collector.

10. The electronic device as claimed in claim 8, wherein the voltage insolating circuit comprises a metal-oxide-semiconductor field-effect transistor (MOSFET), a first resistor, a second resistor, and a third resistor, the MOSFET comprises a source, a gate, and a drain, the source of the MOSFET is electrically connected to the first electronic component, the gate of the MOSFET is electrically connected to the standby power source through the first resistor, the source of the MOSFET is further electrically connected to the standby power supply through the second resistor, and the drain of the MOSFET is electrically connected to the main power supply through the third resistor.

11. The electronic device as claimed in claim 10, wherein the resistors are pull-up resistors.

12. The electronic device as claimed in claim 8, wherein the voltage of the main power supply is greater than the voltage of the standby power supply, the voltage of the main power supply is 5V or 12V, and the voltage of the standby power supply is 3.3V or 5V.

13. The electronic device as claimed in claim 8, wherein the electronic switch is an npn transistor.

14. The electronic device as claimed in claim 8, wherein the current suppression circuit further comprising a diode and a current limiting resistor, the diode comprises an anode and cathode, the output of the voltage comparator is electrically connected to the anode of the diode, the cathode of the diode is electrically connected to the electronic switch through the current limiting resistor.

15. The electronic device as claimed in claim 14, wherein the potential difference of the diode is substantial 0.7V, and the diode filters out noise signals to avoid interfering with the electronic switch.

16. The electronic device as claimed in claim 14, wherein when the electronic device is powered on and is activated, the standby power supply and the main power supply provide electricity to the inverting input and the non-inverting input of the voltage comparator, the voltage of the non-inverting input is greater than the voltage of the inverting input, the output of the voltage comparator outputs a high voltage signal to the diode, the electronic switch is switched on, and the first electronic device communicates with the second electronic device through the voltage insolating circuit and the electronic switch.

17. The electronic device as claimed in claim 16, wherein when the electronic device is powered off, the standby power supply provides electricity for the inverting input, and the main power supply is cut off and is unavailable to power the non-inverting input, the voltage of the inverting input is greater than that of the non-inverting input, the output outputs a low voltage signal to the diode, the diode and the electronic switch are switched off and cease operating, so the standby power supply is made unavailable for the electronic device.

18. The electronic device as claimed in claim 8, wherein the first electronic component is a microprocessor, and the second electronic component is a network interface card or an input/output microchip.

19. The electronic device as claimed in claim 9, wherein the electronic switch is an N-channel MOSFET comprising a gate, a source and a drain, the gate, the source and the drain correspond to the base, the emitter and the collector of the transistor, respectively.
